(19) United States
(12) Patent Application Publication
(10) Pub. No.: US 2023/0211880 A1
(43) Pub. Date: Jul. 6, 2023

(54) UNMANNED AERIAL/GROUND SYSTEM CARGO ALIGNMENT AND CAPTURE SYSTEM

(71) Applicant: TB2 Aerospace LLC, Breckenridge, CO (US)

(72) Inventor: Frank M. Scott, Breckenridge, CO (US)

(21) Appl. No.: 18/048,013

(22) Filed: Oct. 19, 2022

Related U.S. Application Data
(60) Provisional application No. 63/257,348, filed on Oct. 19, 2021.

(51) Int. Cl. B64D 1/08

(52) U.S. Cl. CPC B64D 1/08; B64U 10/00

(57) ABSTRACT

There is disclosed a system for enhanced aerial delivery capability. In an embodiment, there is provided an electro-mechanical cargo alignment and capture system to allow Unmanned Aerial Systems to align and collect/capture external cargo payloads. In another embodiment, there is provided an electro-mechanical cargo alignment and capture system to allow Unmanned Aerial Systems to align and secure external cargo payloads to ground docking stations. Other embodiments are also disclosed.

### REFERENCE TO PENDING PRIOR PATENT APPLICATION

This application claims the benefit under 35 U.S.C. 119 (e) of (1) U.S. Provisional Patent Application No. 63/257,348, filed Oct. 19, 2021 by Frank Scott for “UNMANNED AERIAL/GROUND SYSTEM CARGO ALIGNMENT AND CAPTURE SYSTEM”.

The above-identified patent application is hereby incorporated herein by reference.

### BACKGROUND

Generally, unmanned aerial vehicles (UAVs) or unmanned aerial systems (UAS) may be used for delivering merchandise, supplies, or other materials from one location to another. In many typical arrangements, a cargo container must be attached and detached from one or both of a UAV/UAS or from a ground station with manual interaction. The problem with current unmanned systems is that UAS/UGS homing/landing systems that utilize autonomous guidance such as GPS, LIDAR, Cameras and Infra-red beacons lack the accuracy to align and capture the cargo.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The present disclosure is for a component of an Unmanned Aerial System (UAS), Unmanned Ground System or as a stand-alone rack that could be fitted to any UAS/UGS. Its aim is to allow a UAS to autonomously align the UAS with the cargo container in azimuth, height and alignment. Then to facilitate the docking of the UAS with the cargo container with enough rigor and strength to allow the UAS to capture and then carry the cargo container for flight or ground transportation via electro-mechanical latches.

In other embodiments, a cargo container and a ground station may include alignment and capture components to autonomously align the cargo container with the ground station and to facilitate the docking of the cargo container with the ground station.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a cargo pod having a pyramid shape together with hard portions configured to dock with a UAV.

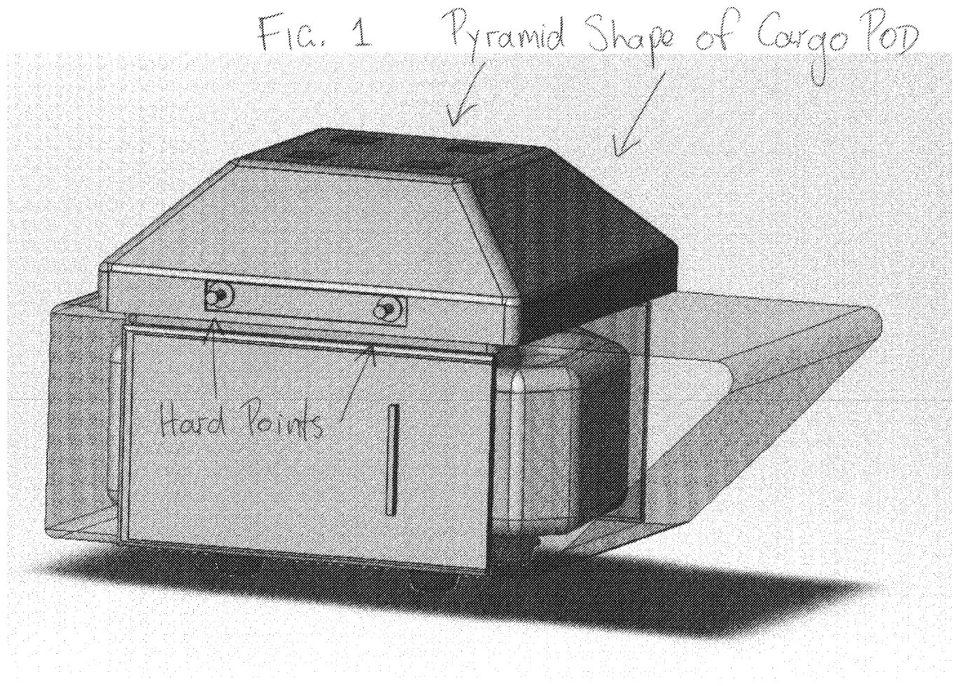

FIG. 2 illustrates a cargo pad with an alignment pyramid, a UAV rack having an upper alignment pyramid, and latches for selective attachment of the cargo pad and a UAV rack with one another.

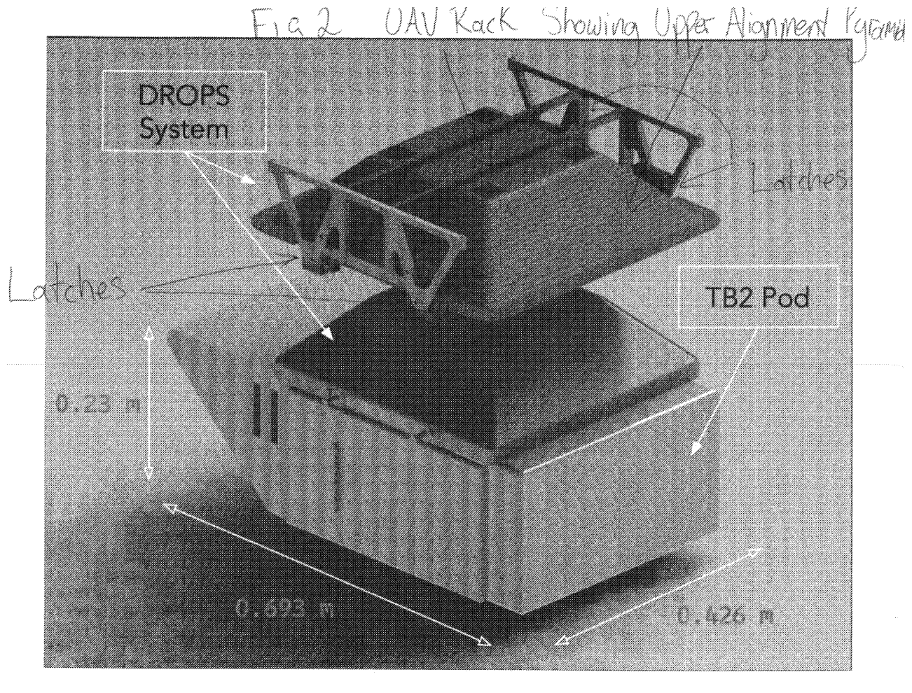

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

The present disclosure seeks to address the current problem of UAS's, specifically that they require some form of human interaction to connect their cargo with the UAS/UGS. Many systems exist to autonomously deliver cargo from an UAS/UGS to their destination and release the cargo autonomously, but few exist that allow the UAV to actually pick-up the cargo without human assistance.

The design of the aerial system/UAV may be at the discretion of the operator of the aerial system/UAV.

The design of this system may be as a stand-alone rack that could be retrofitted to any suitable UAS/UGS or it could be incorporated into the basic design of the UAS/UGS.

This system may designed to fulfil the final alignment and capture issues currently preventing autonomous alignment and capture of the cargo. It utilizes a pyramid shaped cargo POD upper surface and an inverted pyramid shape to allow both components to connect and align under the force of gravity. Once these two surfaces align in azimuth and height the final capture of the UAV to the cargo would be via latches that electronically rotate to seat the receiving pins or hard points to the UAV rack. The latches would be mounted on the UAV rack, the pins/hard points would be mounted on the cargo POD.

Autonomous collection and delivery of cargo by UAS/UGS systems have multiple commercial, NGO, Government and Military applications.

The design is an electromechanical alignment and capture system.

Certain embodiments of the present invention include, but are not limited to:

Standardized design features include standardized:
A rack unit that interfaces the UAV to the intended Cargo POD.
A central frame that would support the entire system.
An angular housing on both the cargo and the UAV Rack Unit.
Electro-mechanical, or electro-magnetic securement (capture) actuators to secure a strong capture of the cargo.

As the UAS/UGS navigates to the intended cargo it will utilize a variety of commercially available avionics/navigation systems to close in on the cargo POD. The UAS/UGS will maneuver as close as possible to the cargo. The UAS/UGS will then lower itself to merge with the pyramid-shaped upper housing of the cargo POD. The mating of these two identical shapes serves to align the POD/UAV and the intended cargo in azimuth and also allow both units to become more centered as the Cargo POD and Rack/UAV get closer.

Once the two units are close enough four or more electro-mechanical latching mechanisms attached to the rack/UAV will rotate closed on the four mounting bolts/hard point connections of the cargo POD.

The added application of electro-mechanical actuators may be employed to increase the capture force applied by the arms. In turbulence or other conditions that preclude a secure mating of the Cargo POD and the UAV/Rack a human could complete the seating of the hard points into the latching system by applying physical force. Alternatively, the final seating and capture could be achieved by applying an electro-magnetic force between the rack-mounted electro-magnet and steal target plated/hard points on the cargo POD.

A reversal of this force would be used to release the cargo for ground or airborne release/delivery although these systems are covered in prior art and not the subject of this application.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A system for enhanced aerial delivery capability, the system comprising:
a UAV having one or more motors for powered flight, and the UAV having an alignment pyramid, and a latch system;
a pod having a cargo portion to selectively carry a payload, and the pod having a corresponding alignment pyramid configured to dock with the alignment pyramid of the UAV, and a corresponding latch system configured to secure the pod to the UAV; and
an autonomous mounting system configured to provide selective and autonomous mechanical connection of the pod with the UAV, the mounting system configured to provide an electro-mechanical cargo alignment and capture system to allow the UAV to align and capture a pod.

2. The system of claim 1, where in the latches include an electro-magnet.

3. A system for enhanced aerial delivery capability, the system comprising:
a docking station having an alignment pyramid, and a latch system;
a cargo pod having a cargo portion to selectively carry a payload, and the cargo pod having a corresponding alignment pyramid configured to dock with the alignment pyramid of the docking station, and a corresponding latch system configured to secure the cargo pod to the docking station; and
an autonomous mounting system configured to provide selective and autonomous mechanical connection of the pod with the docking station for capturing and selectively retaining the cargo pod, and the docking station, the mounting system configured to provide an electro-mechanical cargo alignment and capture system to allow the UAV to align and capture a pod.

4. The system of claim 3, where in the latches include an electro-magnet.
